(19) United States
(12) Patent Application Publication
(10) Pub. No.: US 2016/0110321 A1
(43) Pub. Date: Apr. 21, 2016

(54) APPLICATION CUSTOMIZATION THROUGH LINKED EMBEDDED AREAS

(71) Applicants: Karol Kalisz, Sandhausen (DE); Yuqian Song, Dublin (IE); John Costello, Thomastown (IE); Paul Sheedy, Dublin (IE)

(72) Inventors: Karol Kalisz, Sandhausen (DE); Yuqian Song, Dublin (IE); John Costello, Thomastown (IE); Paul Sheedy, Dublin (IE)

(21) Appl. No.: 14/516,923

(22) Filed: Oct. 17, 2014

(51) Int. Cl. G06F 17/22; H04L 29/08

(52) U.S. Cl. CPC G06F 17/2235; G06F 17/2247; H04L 67/02

(57) ABSTRACT

Examples of application customization through linked embedded areas are provided herein. Linked embedded areas can be used to customize an application in a way that allows both user customization and application provider application updates. In response to receiving a request to initiate an application, static content portions of the application can be accessed, and embedded areas of the application can be identified. Embedded areas are linked to content variants that include information representing content displayable in the embedded area. The content variant linked to the embedded area of the application can be retrieved, and a user-specific instance of the application can be generated. The user-specific instance includes the static content portions and the embedded area. The content displayed in the embedded area reflects the content variant.

### BACKGROUND

With the increasing complexity and functionality of software applications, users are increasingly demanding the ability to customize. In addition to conventional customization such as selecting a “theme” or other general appearance or selecting certain functionality options to appear in particular menus, users often desire additional levels of customization. Some applications allow for more detailed customization, but such applications typically preserve this customization by tracking the state of the entire application. Preservation of the entire state of an application limits the ability of an application provider to update the application.

### BRIEF DESCRIPTION OF THE DRAWINGS

FIG. 1 is an example application customization system.

FIG. 2 illustrates an example user interface of an application including user-customizable embedded areas.

FIG. 3 illustrates an example method for customizing an application.

FIG. 4 illustrates an example method for altering content displayed in an embedded area.

FIG. 5 illustrates an example method for generating a user-specific application instance after an application design update.

FIG. 6 illustrates an example user interface of an application configured to create content variants.

FIG. 7 illustrates an example user interface of an application configured to select content variants from a content variant gallery.

FIG. 8 illustrates an example method for updating the displayed content of a user-specific application instance after a user interaction.

FIG. 9 is a diagram illustrating a generalized implementation environment in which some described examples can be implemented.

### DETAILED DESCRIPTION

The examples described herein generally allow customization of applications. The described examples allow users to customize applications while at the same time allowing application providers to update the design of the applications without interfering or conflicting with the user customization. In the described examples, applications include embedded areas that can be customized by a user as well as static content portions that are typically not customizable by a user and instead can be configured by an application provider. A user can customize the content displayed within an embedded area by linking the embedded area to a particular content variant that determines what content is displayed in the embedded area. Users can select from pre-determined content variants or can create content variants to reflect changes the users have made to an application.

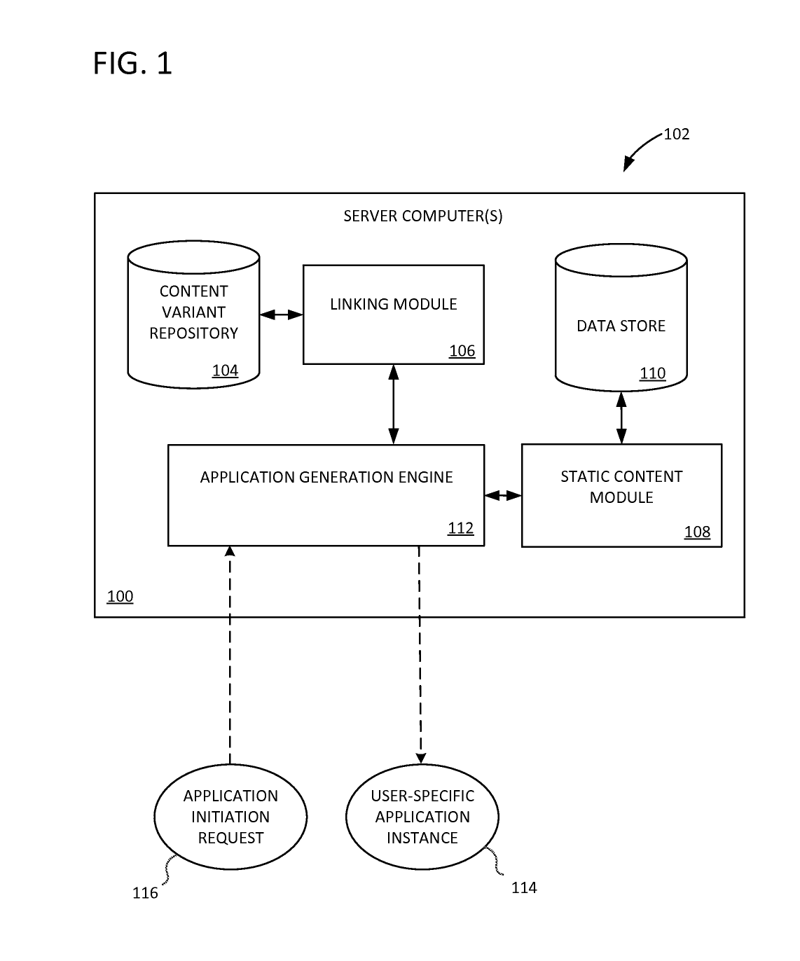

For example, a user can select a dataset, apply a filter, and construct a visualization of the filtered data. The user can then create a content variant to represent the visualization of the filtered data, and an embedded area in the application can be linked to the content variant, causing the visualization of the filtered data to be displayed in the embedded area. Using the link between the content variant and the embedded area, when the user subsequently initiates the application, a user-specific instance can be generated that includes the visualization of the filtered data in the embedded area. The link between the content variant and the embedded area preserves the user customization in a modular way that does not rely on preserving the state of the entire application instance. Application providers, in contrast, can determine the content of the static content portions. In this way, application providers have the flexibility to update aspects of an application reflected in the static content portions while still allowing users to customize aspects of the application reflected in the embedded areas. This approach to customization reduces the use of computing resources and time necessary for a user to reach a preferred state in an application. Additionally, embedded areas in an application reduce or eliminate the need to store user-specific instances of the application, reducing the use of storage resources. Instead of storing user-specific instances of a stored application along with the stored application itself, user-specific instances can be dynamically created for a user session by loading the stored application and retrieving information specified in linked content variants. Examples are described below with reference to FIGS. 1-9.

FIG. 1 illustrates one or more server computers 100 implementing an application customization system 102. System 102 includes a content variant repository 104 that stores a plurality of content variants associated with a user-customizable embedded area of an application. Applications can also have a plurality of embedded areas. An embedded area can be thought of as an area of an application user interface designated for displaying user-customized or user-selected content. In some examples, the embedded area includes default content if a user has not selected or created a content variant.

Each content variant includes information describing a different option for content displayable within the embedded area. A content variant can comprise a serialized (e.g., serialized to a string) meta model that is independent of the underlying rendering technology, allowing a variety of software capable of understanding the meta model to access and load the information in the content variant. A content variant can be, for example, a hypertext markup language (HTML) representation, an extensible markup language (XML) representation of content, or other serializable name-value pair notation. The information representing all objects contained in the content variant can be stored in the meta model. The meta model can be configured to be understandable to many software components, independent of the underlying infrastructure. For example, if a user creates a content variant to reflect a data visualization while working in an object-based (e.g. HTML) web application, the user can also create a user-specific instance of the application and link to the created content variant while on a non-HTML platform (e.g. some mobile frameworks).

A content variant can include information describing a variety of aspects of content, including stylistic information, data visualization information, or menu or feature customization information. Data visualization information can include, for example, a data source reference, a graph type or chart type, a data filter, axis information, scale information, data sorting information, symbol information, or legend information. A content variant comprising a meta model representation (e.g., an XML object model or JavaScript Object Notation (JSON) object model) can, for example, be serialized and de-serialized into and from XML string or JSON and stored in a database and/or as a table. The meta model can be read and visualized by different applications that understand the serialization of the meta model. The respective different applications can deserialize and perform visualization through the particular routines used by the application (e.g., HTML representation for a web application).

Content variants can be associated with embedded areas through the use of, for example, an identifier. An identifier can be assigned to an embedded area(s), and content variants that can be used with the embedded area(s) can also contain the identifier. In some examples, an identifier is unique to an application. For example, a first embedded area in an application can have an identifier “AREA_A,” and a second embedded area in the application can have an identifier “AREA_B.” A content variant that corresponds to embedded area “AREA_A” can contain the “AREA_A” identifier along with a descriptive identifier or other identifier for the content variant itself.

In some examples, an embedded area can be used in multiple applications. For example, an embedded area can have a same size, shape, or other feature that is consistent regardless of the application in which an application provider has included the embedded area. In such cases, the embedded area can have an identifier that is unique across the multiple applications. A content variant associated with an embedded area that can be used in multiple applications can, in some examples, be accessed through the multiple applications. That is, if a user creates a content variant in “Application A” that is associated with an embedded area having an identifier “LEFT_SIDEBAR,” and the same embedded area is also included in “Application B,” then the user can, in “Application B,” select the content variant created in “Application A” for use with the embedded area in “Application B.” In some examples, the content variants stored in content variant repository 104 can be shared between users.

Linking module 106 identifies a content variant, of the plurality of content variants stored in content variant repository 104, that is linked to the user-customizable embedded area. In some examples, a single content variant is linked to the embedded area. In other examples, multiple content variants are linked to the embedded area. For example, multiple linked content variants can represent content displayable in spatially different portions of the embedded area that do not interfere with each other. The linked content variant is the content variant that is “active” for the embedded area. Other content variants in content variant repository 104 may be associated with the embedded area, but the information contained in the linked content variant(s) is used to determine what is displayed in the embedded area.

Static content module 108 retrieves one or more static content portions of the application from data store 110. Static content portions are typically not customizable by a user, but static content portions can have dynamic features that change as a result of changes to embedded areas. Static content portions can be, for example, determined by application providers (and application designers). Data store 110 can store a variety of data, including static content portions, data accessed by users of the application, and other data.

Application generation engine 112 generates a customized instance 114 of the application upon receiving an instruction 116 to initiate the application. The customized instance includes the retrieved static content portions and the user-customized embedded area. Content within the user-customizable embedded area is determined by the content variant linked to the user-customizable embedded area. In some examples, the application is a web application provided over the internet.

In some examples, the user-customizable embedded area is a first user-customizable embedded area, at least some of the plurality of content variants stored in content variant repository 104 are also associated with, and are linkable to, a second user-customizable embedded area in an additional application. In some examples, application generation engine 112 generates a customized instance of an additional application upon receiving an instruction to initiate the additional application. The customized instance of the additional application includes the second user-customizable embedded area. The second user-customizable embedded area is linked to the same content variant that is linked to the first user-customizable embedded area.

In FIG. 1, the arrows indicating communication between system components are only an example. Any of the components of system 102 can be in communication with any other components. In examples in which system 102 is implemented on multiple server computer(s) 100, server computers 100 can be in communication via a network (not shown). The network can be the Internet, a local area network (LAN), a wireless local area network (WLAN), a wide area network (WAN), or other type of network, wired or wireless. Application initiation instructions 116 can be received via the network, and user-specific application instance 114 can be provided via the network.

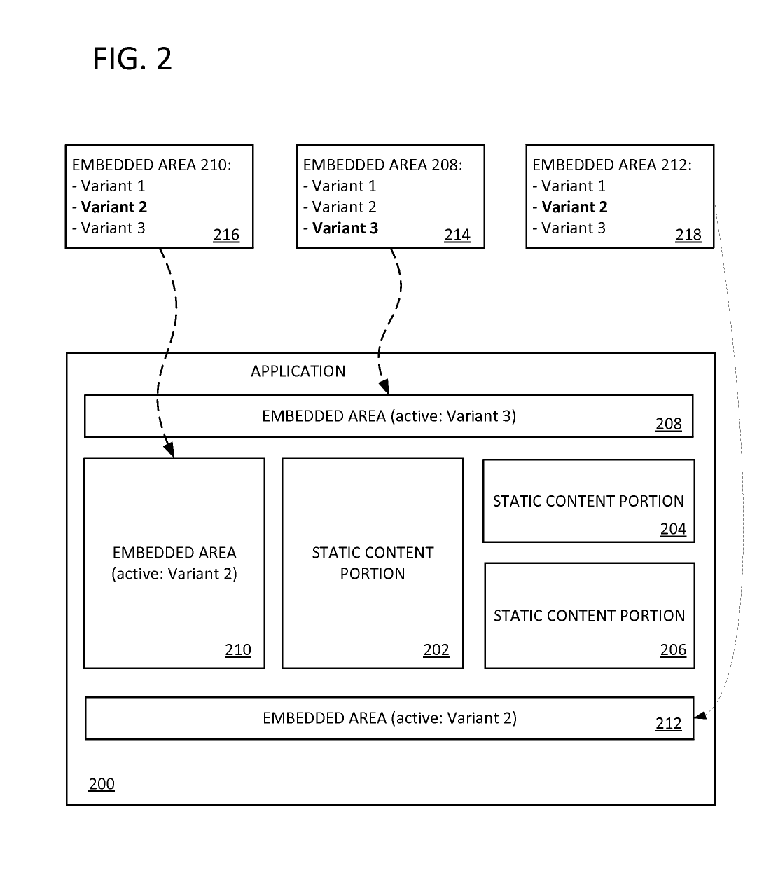

FIG. 2 illustrates an example user interface 200 of an application. Interface 200 includes static content portions 202, 204, and 206 as well as embedded areas 208, 210, and 212. In embedded area 208, content variant “Variant 3” is “active” or linked to embedded area 208. Informational box 214 illustrates the available content variants that are associated with embedded area 208 (“Variant 1,” “Variant 2,” and “Variant 3”). Similarly, informational box 216 lists available content variants (“Variant 1,” “Variant 2,” and “Variant 3”) for embedded area 210. Although informational box 214 and 216 both list “Variant 1,” “Variant 2,” and “Variant 3,” the respective content variants also contain an identifier associating them with the corresponding embedded area. Thus, “Variant 1” associated with embedded area 210 can include both an identifier for embedded area 210 as well as another identifier (e.g. “Variant 1”) that allows the content variant to be distinguished from other content variants associated with embedded area 210. Informational box 218 illustrates the available content variants associated with embedded area 212.

The content variants available for embedded areas 208, 210, and 212 can be stored, for example, in a content variant repository. In some examples, content variants associated with a respective embedded area are stored together but separately from content variants associated with other embedded areas. In other examples, the content variants are stored together and are searchable by identifier(s).

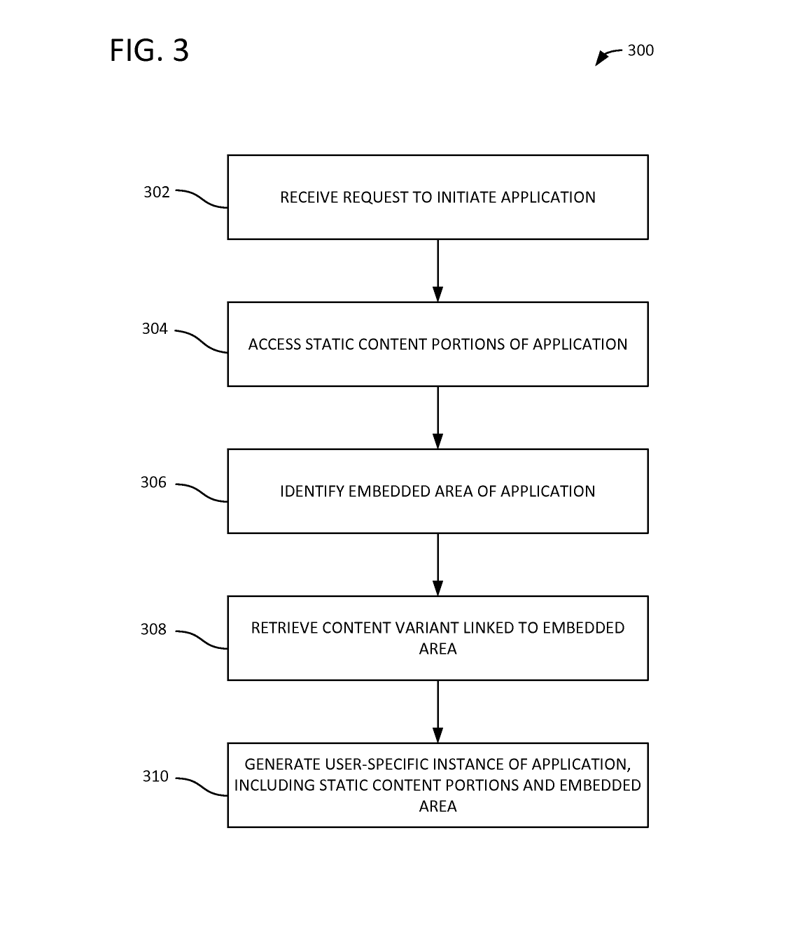

FIG. 3 illustrates a method 300 of customizing an application. In process block 302, a request to initiate the application is received. The request can be, for example, a request received over the Internet to initiate a web application. The request can also be a request to initiate an application that is installed at a local computing device or that is accessed through a LAN or other network. In process block 304, one or more static content portions of the application are accessed. In process block 306, an embedded area of the application is identified. The embedded area is linked to a content variant. The content variant comprises information representing content displayable in the embedded area. The information can include, for example, data visualization information. The content variant linked to the embedded area of the application is retrieved in process block 308. In process block 310, a user-specific instance of the application is generated. The user-specific instance includes the one or more static content portions and the embedded area. The content of the embedded area is based at least in part on the content variant.

In some examples, a user instruction to link the embedded area to a second content variant in place of the first content variant is received. In response to the user instruction, the embedded area is modified to reflect the second content variant (i.e., the displayed content is updated to display the content described by the second content variant).

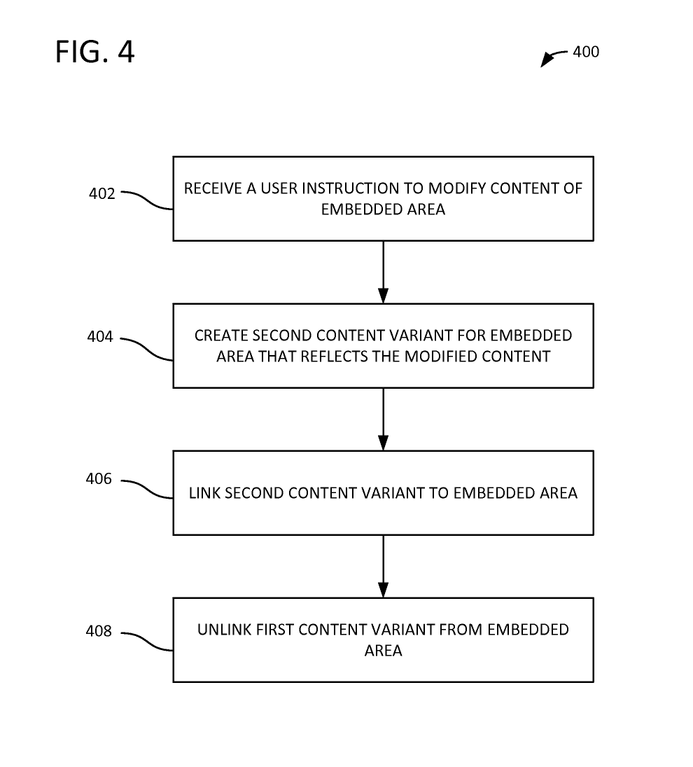

FIG. 4 illustrates a method 400 of altering the content displayed in an embedded area. Method 400 can be performed, for example, after method 300 of FIG. 3. In process block 402, a user instruction to modify the content of an embedded area is received. The embedded area is linked to a first content variant. In process block 404, a second content variant for the embedded area is created. The second content variant reflects the user instruction to modify the content. For example, the second content variant can reflect changes a user made to a data visualization. In process block 406, the second content variant is linked to the embedded area. The first content variant is then unlinked from the embedded area in process block 408. In some examples, an unlinked content variant can be deleted by the user and removed from a content variant repository or other storage.

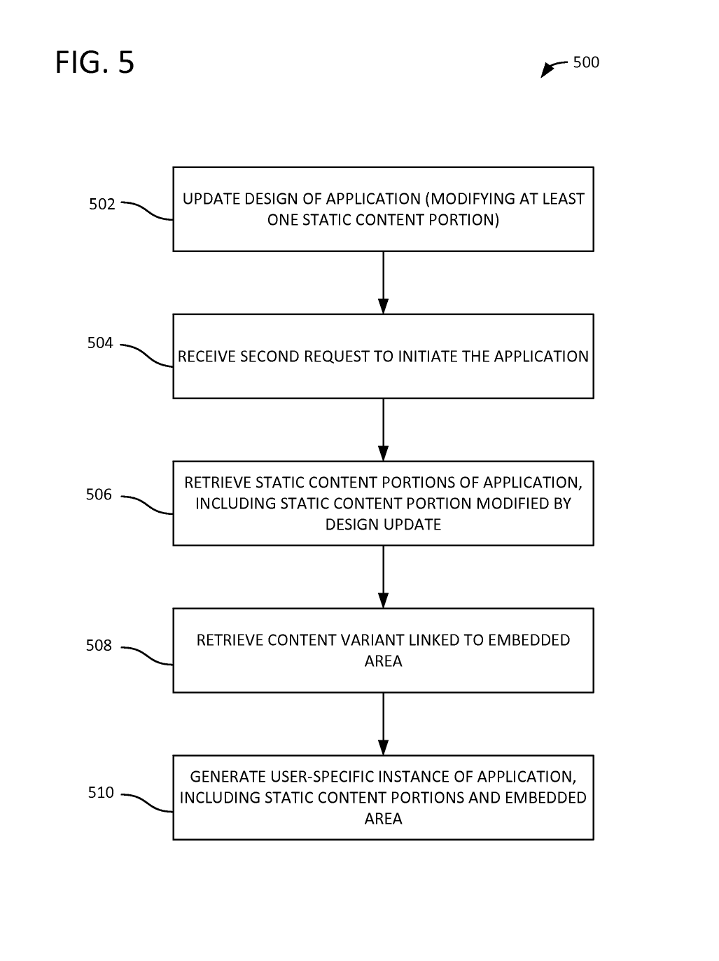

FIG. 5 illustrates a method 500 of generating a user-specific application instance after an application design update. Method 500 can be performed, for example, after method 300 in FIG. 3. In process block 502, after the user-specific instance of the application has been generated, a design of the application is updated. The updating comprises modifying at least one static content portion. The updating can be performed by an application provider, for example. In the context of a web application, the update can be performed at the provider's end and is implemented when a user next initiates the application over the Internet. In a local application context, an application update can, for example, be transmitted to the user for installation from an application provider.

In process block 504, after the design of the application has been updated, a second request to initiate the application is received. The static content portions of the application are retrieved in process block 506. The static content portions of the application include at least one modified static content portion that reflects the updated design of the application. The updated design can include, for example, the addition or removal of a menu item, functionality, or graphic, a reorganization of static content portions, the addition or removal of a static portion, etc. In process block 508, the content variant linked to the embedded area of the application is retrieved. In process block 510, a second user-specific instance of the application is generated, the second instance including the at least one modified static content portion that reflects the updated design of the application and including the embedded area. The content of the embedded area remains based at least in part on the content variant. Thus, in method 500, the design of an application is updated (by modifying the static content portions) without affecting the user's customization (content displayed in the embedded area). Because the embedded area is linked to a content variant, the link remains unchanged through the modification of the static content portions, and the content variant can simply be retrieved and incorporated into the generated user-specific instance of the application.

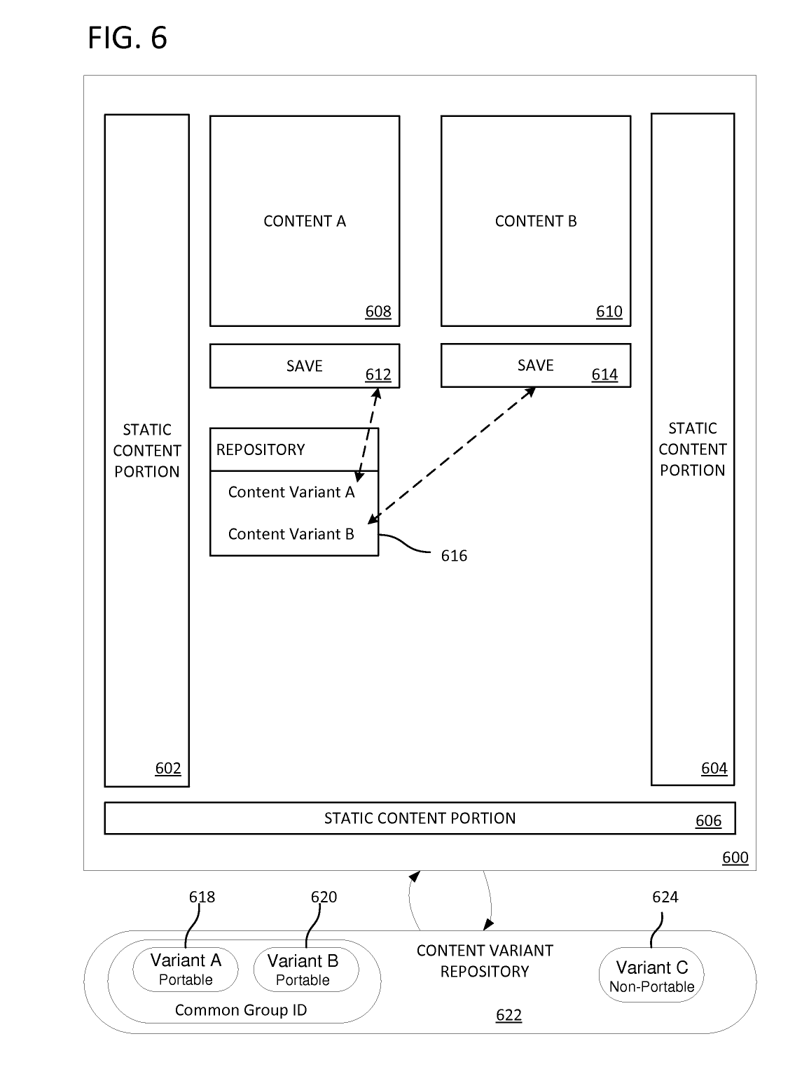

FIG. 6 illustrates an example user interface 600 of an application in which content variants can be created. The application can be a “creation” application specifically configured for creating and saving content variants or can be an application, such as a data visualization tool, in which functionality for creating and storing content variants is enabled. User interface 600 includes static content portions 602, 604, and 606 as well as embedded areas 608 and 610. Embedded area 608 displays “Content A,” and embedded area 610 displays “Content B.” Save buttons 612 and 614 allow the user to save “Content A” and “Content B” as content variants, illustrated in repository view window 616.

“Content Variant A” 618 and “Content Variant B” 620 are shown stored as “portable” in content variant repository 622. Portable content variants can be used by other users and/or by other applications, whereas “non-portable” content variants are application and/or user specific. Content variant repository 622 also contains an additional content variant, “Content Variant C” 624, which is shown as non-portable. The “Common Group ID” shown in FIG. 6 with respect to “Content Variant A” 618 and “Content Variant B” 620 can indicate that the variants are associated with a particular group or application.

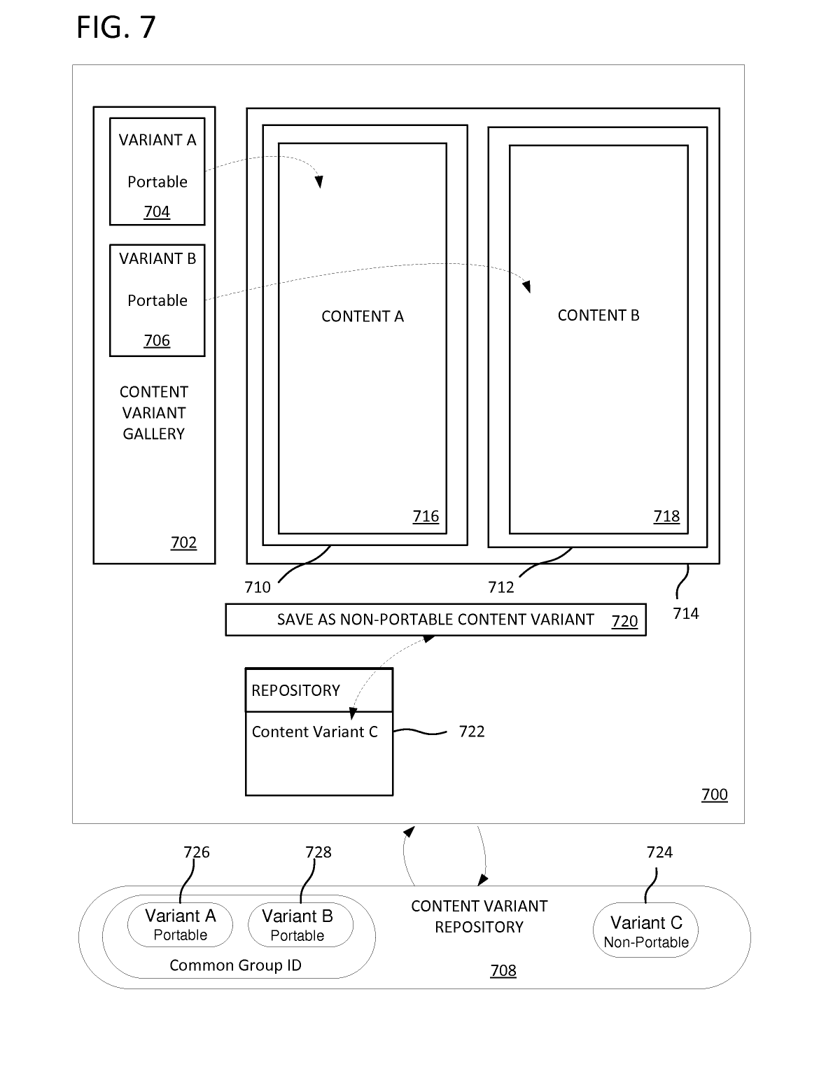

FIG. 7 illustrates a user interface 700 in an application in which content variants can be selected in embedded areas. User interface 700 includes content variant gallery 702, which contains available content variants, including “Variant A” 704 and “Variant B” 706, similar to the corresponding content variants created in FIG. 6. Content variant gallery 702 can self-populate or be otherwise populated, for example, by searching content variant repository 708 for content variants associated with embedded areas 710 and 712 or with the application, user, or group of users (e.g. group within an organization).

A user can drag and drop these content variants into embedded areas 710 and 712, shown within window 714. Embedded area 710 displays “Content A” 716, and embedded area 712 displays “Content B” 718, which are displayed as a result of moving “Variant A” 704 and “Variant B” 706 from content variant gallery 702 into embedded areas 710 and 712. Other ways to select content variants are also possible, including selection from a drop-down or other menu, right-clicking or hovering over an embedded area to cause a gallery, menu, or list to appear, or other way. For example, in response to a user interaction with an embedded area, references to a plurality of additional content variants that are associated with the embedded area and available for selection can be presented. Although “Variant A” 704 and “Variant B” 706 are shown in content variant gallery 702, they may not be linked to embedded areas 710 and 712 until the user instructs the application to link the content variants to the embedded areas. In some examples, moving a content variant from content variant gallery 702 into an embedded area links the content variant to the embedded area.

A user can make further modifications to “Content A” 716 and/or “Content B” 718. Save button 720 provides the option to save a new content variant (shown as “Content Variant C” in repository view window 722) as a non-portable content variant to represent the modified content of embedded areas 710 and/or 712. “Content Variant C” is shown saved as non-portable “Variant C” 724 in content variant repository 708. “Variant A” 726 and “Variant B” 728 are also shown stored in content variant repository 708, similar to FIG. 6. In some examples, a creation application such as that shown in FIG. 6 is used to create portable content variants that can be shared among users and applications, and other applications, such as that shown in FIG. 7, are used to create non-portable content variants that are user and/or application specific. In other examples, all of the functionality described with respect to FIGS. 6 and 7 is available in a single application.

In some examples, a power user or administrator can manage the content variants created or accessed by users by organizing access, deletion, and provisioning roles for sharing in the system landscape.

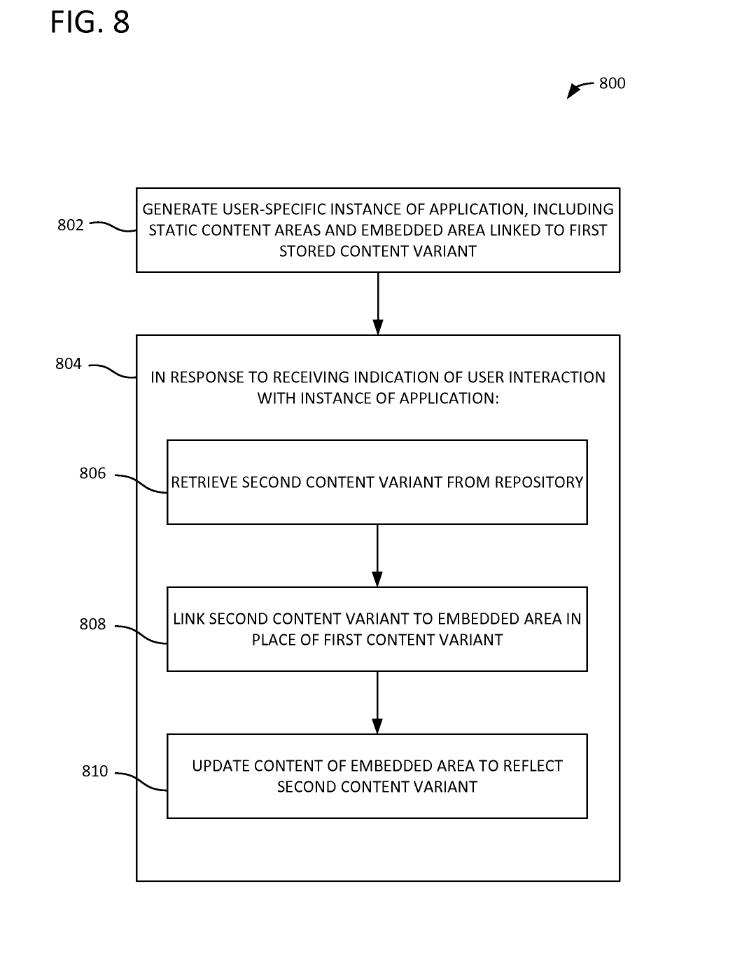

FIG. 8 illustrates a method 800 of customizing an application. In process block 802, a user-specific instance of the application is generated. The instance of the application includes a plurality of static content areas and an embedded area linked to a user-selected first content variant stored in a content variant repository. The first content variant determines, at least in part, content displayed in the embedded area. In process block 804, in response to receiving an indication of user interaction with the instance of the application, process blocks 806, 808, and 810 are performed. In process block 806, a second content variant is retrieved from the content variant repository. The content variant repository stores additional content variants corresponding to the embedded area. In process block 808, the second content variant is linked to the embedded area in place of the first content variant. Linking the second content variant to the embedded area associates the second content variant with the embedded area for generation of subsequent user-specific instances of the application. In process block 810, the content of the embedded area is updated to reflect the second content variant.

In some examples, the content variant repository stores content variants for a plurality of embedded areas. The additional content variants can include an identifier indicating that the additional content variants are available for use with the embedded area.

In some examples, method 800 can further comprise additional process blocks prior to retrieving the second content variant from the content variant repository and in response to receiving the indication of user interaction with the instance of the application. For example, a plurality of the additional content variants in the content variant repository that are associated with the embedded area can be identified; references to the respective additional content variants of the plurality of the additional content variants can be provided for selection; and an indication of a user selection of the second content variant can be received.

### Examples of Computing Environments

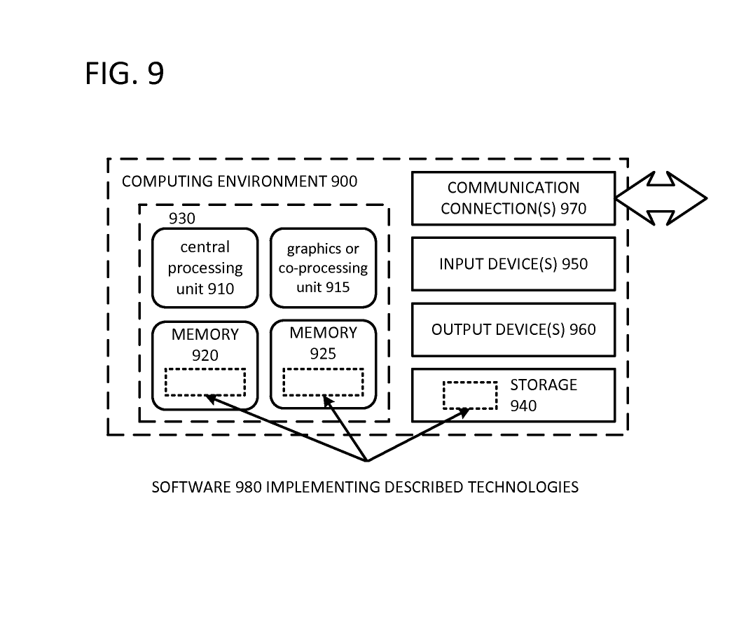

FIG. 9 depicts a generalized example of a suitable computing environment 900 in which the described innovations may be implemented. The computing environment 900 is not intended to suggest any limitation as to scope of use or functionality, as the innovations may be implemented in diverse general-purpose or special-purpose computing systems. For example, the computing environment 900 can be any of a variety of computing devices (e.g., desktop computer, laptop computer, server computer, tablet computer, media player, gaming system, mobile device, etc.)

With reference to FIG. 9, the computing environment 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s). For example, memory 920 and 925 and software 980 can store computer-executable instructions for customizing applications.

A computing system may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The tangible storage 940 may be removable or non-removable, and includes magnetic disks, magnetic tapes or cassettes, CD-ROMs, DVDs, or any other medium which can be used to store information and which can be accessed within the computing environment 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing environment 900. For video encoding, the input device(s) 950 may be a camera, video card, TV tuner card, or similar device that accepts video input in analog or digital form, or a CD-ROM or CD-RW that reads video samples into the computing environment 900. The output device(s) 960 may be a display, printer, speaker, CD-writer, or another device that provides output from the computing environment 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Pert, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

What is claimed is:

1. One or more computer-readable storage media storing instructions that, when executed by a computing device, perform a method of customizing an application, the method comprising:
receiving a request to initiate the application;
accessing one or more static content portions of the application;
identifying an embedded area of the application, wherein the embedded area is linked to a content variant, and wherein the content variant comprises information representing content displayable in the embedded area;
retrieving the content variant linked to the embedded area of the application; and
generating a user-specific instance of the application including the one or more static content portions and the embedded area, wherein content of the embedded area is based at least in part on the content variant.

2. The computer-readable storage media of claim 1, wherein the content variant comprises a serialized meta model describing objects contained in the content variant, and wherein the meta model is serialized using a name-value pairs notation.

3. The computer-readable storage media of claim 2, wherein the name-value pairs notation comprises at least one of extensible markup language (XML) or JavaScript Object Notation (JSON).

4. The computer-readable storage media of claim 1, wherein the application is a web application provided over the Internet.

5. The computer-readable storage media of claim 1, wherein the information comprises data visualization information, and wherein the data visualization information includes at least one of: a data source reference; a graph type or chart type; a data filter; axis information; scale information; data sorting information; symbol information; or legend information.

6. The computer-readable storage media of claim 1, wherein the content variant is a first content variant, and wherein the method further comprises:
receiving a user instruction to modify the content of the embedded area;
creating a second content variant for the embedded area, the second content variant reflecting the user instruction to modify the content;
linking the second content variant to the embedded area; and
unlinking the first content variant from the embedded area.

7. The computer-readable storage media of claim 1, wherein the content variant for the embedded area is a first content variant, and wherein the method further comprises:
receiving a user instruction to link the embedded area to a second content variant in place of the first content variant; and
modifying the embedded area to reflect the second content variant.

8. The computer-readable storage media of claim 7, wherein the first content variant and the second content variant are stored in a content variant repository accessible to at least one of a plurality of users or a plurality of applications.

9. The computer-readable storage media of claim 7, wherein the first content variant and the second content variant contain an identifier that associates the first content variant and the second content variant with the embedded area.

10. The computer-readable storage media of claim 1, wherein the method further comprises:
in response to a user interaction with the embedded area, presenting references to a plurality of additional content variants that are associated with the embedded area and available for selection.

11. The computer-readable storage media of claim 1, wherein the one or more static content portions are determined by an application provider.

12. The computer-readable storage media of claim 1, wherein the method further comprises:
after the user-specific instance of the application has been generated, updating a design of the application, wherein the updating comprises modifying at least one static content portion;
after the design of the application has been updated, receiving a second request to initiate the application;
retrieving the one or more static content portions of the application, including at least one modified static content portion that reflects the updated design of the application;
retrieving the content variant linked to the embedded area of the application; and
generating a second user-specific instance of the application including the at least one modified static content portion that reflects the updated design of the application and including the embedded area, wherein the content of the embedded area remains based at least in part on the content variant.

13. A computer-implemented method of customizing an application, the method comprising:
generating a user-specific instance of the application, the instance of the application including a plurality of static content areas and an embedded area linked to a user-selected first content variant stored in a content variant repository, wherein the first content variant determines, at least in part, content displayed in the embedded area; and
in response to receiving an indication of user interaction with the instance of the application:
retrieving a second content variant from the content variant repository, the content variant repository storing additional content variants corresponding to the embedded area; and
linking the second content variant to the embedded area in place of the first content variant, wherein linking the second content variant to the embedded area associates the second content variant with the embedded area for generation of subsequent user-specific instances of the application; and
updating content of the embedded area to reflect the second content variant.

14. The computer-implemented method of claim 13, wherein the first and second content variants comprise data visualization information.

15. The computer-implemented method of claim 13, wherein the content variant repository stores content variants for a plurality of embedded areas, and wherein the additional content variants include an identifier indicating that the additional content variants are available for use with the embedded area.

16. The computer-implemented method of claim 13, wherein prior to retrieving the second content variant from the content variant repository, the method further comprises: in response to receiving the indication of user interaction with the instance of the application:
identifying a plurality of the additional content variants in the content variant repository that are associated with the embedded area;
providing, for selection, references to the respective additional content variants of the plurality of the additional content variants; and
receiving an indication of a user selection of the second content variant.

17. One or more server computers implementing an application customization system, the system comprising:
a content variant repository storing a plurality of content variants associated with a user-customizable embedded area of an application, wherein the respective content variants describe different options for content displayable within the embedded area;
a linking module that identifies a content variant, of the plurality of content variants stored in the content variant repository, that is linked to the user-customizable embedded area;
a static content module that retrieves one or more static content portions of the application; and
an application generation engine that generates a customized instance of the application upon receiving an instruction to initiate the application, the customized instance including the retrieved static content portions and the user-customized embedded area, wherein content within the user-customizable embedded area is determined by the content variant linked to the user-customizable embedded area.

18. The one or more server computers of claim 17, wherein the user-customizable embedded area is a first user-customizable embedded area, and wherein at least some of the plurality of content variants stored in the content variant repository are also associated with, and are linkable to, a second user-customizable embedded area in an additional application.

19. The one or more server computers of claim 18, wherein upon receiving an instruction to initiate the additional application, the application generation engine generates a customized instance of the additional application, and wherein the customized instance of the additional application includes the second user-customizable embedded area, and wherein the second user-customizable embedded area is linked to the same content variant that is linked to the first user-customizable embedded area.

20. The one or more server computers of claim 17, wherein the application is a web application provided over the Internet, wherein the plurality of content variants are serialized meta models, and wherein the meta models are serialized using a name-value pairs notation.
